(19) United States
(12) Patent Application Publication
(10) Pub. No.: US 2012/0062737 A1
(43) Pub. Date: Mar. 15, 2012

(54) METHOD AND SYSTEM FOR TRANSMITTING DATA FILE

(75) Inventor: Kyung-Jae JUN, Kyongsangbuk-do (KR)

(73) Assignee: SAMSUNG ELECTRONICS CO., LTD., Gyeonggi-Do (KR)

(21) Appl. No.: 13/228,704

(22) Filed: Sep. 9, 2011

(30) Foreign Application Priority Data
Sep. 9, 2010 (KR) 10-2010-0088515

(51) Int. Cl. H04N 7/01; H04N 7/18

(52) U.S. Cl. 348/143; 348/441; 348/E07.003; 348/E07.085

(57) ABSTRACT

In a system for transmitting a data file, a first terminal calculates sizes of data fields for a displayed target data file on a frame basis, totals the calculated sizes, code-converts a data file having the totaled size, and encodes the code-converted data file, and a second terminal captures the target data file displayed on the first terminal using a camera at N frames-per-second (fps) (where N is an integer), and decodes the captured data file.

### CLAIM OF PRIORITY

This application claims the benefit under 35 U.S.C. §119 of a Korean Patent Application filed in the Korean Intellectual Property Office on Sep. 9, 2010 and assigned Serial No. 10-2010-0088515, the entire disclosure of which is hereby incorporated by reference.

### BACKGROUND OF THE INVENTION

1. Field of the Invention

The present invention relates to a method and system for exchanging data between terminals.

2. Description of the Related Art

There is a growing trend in utilizing large display devices during lectures or advertisements. In the lecture application, a large display device displays video content relating to a particular subject, while an exchange of document can be performed through another route. For example, to give students assignments or to distribute lecture materials, the speaker may inform the students of a Uniform Resource Locator (URL) of the web site where they may download the related files, or must upload the files to the web board.

Meanwhile, in the advertisement application, a URL of the web site from which advertising materials may be downloaded is displayed on the display device, and a user may access the advertising web site later, for example, at home to download the advertising materials.

However, to download specific data other than via the URL displayed on the large display device, the user must inconveniently access the related web site of the lecturer or advertiser using a separate device, and may obtain the data after processing complicated settings between devices. Therefore, a new technology is required that allows a user to share data more conveniently and expediently.

### SUMMARY OF THE INVENTION

An aspect of the present invention is to address at least the above-mentioned problems and/or disadvantages and to provide at least the advantages described below. Accordingly, an aspect of the present invention is to provide a method and system, in which data displayed on a screen of a first terminal is captured using a camera of a second terminal, and differences between actual pixel data of frames of screen output image data from the first terminal, which is received through the camera of the second terminal, are calibrated using a pixel chart for calibration of pixel data, to thereby enable data exchange between terminals without separate connections (through wire/wireless networks, cables, etc.) and settings.

In accordance with one aspect of the present invention, a system for transmitting a data file includes a first terminal for calculating sizes of data fields for a displayed target data file on a frame basis, totaling the calculated sizes, code-converting a data file having the totaled size, and encoding the code-converted data file; and a second terminal for capturing the target data file displayed on the first terminal using a camera at N frames-per-second (fps) (where N is an integer) and decoding the captured data file.

In accordance with another aspect of the present invention a method for transmitting a data file includes calculating sizes of data fields for a displayed target data file on a frame basis, and totaling the calculated sizes; parsing information about data fields in each frame of a data file generated to have the totaled size, converting binary hex code data into code data being different from the hex code data, and encoding the converted code data; and capturing the target data at N frames-per-second (fps) (where N is an integer), de-converting the captured data in units of a predetermined number of bits, converting the bits into an image data file, and decoding the image data file.

A display terminal for transmitting data including a processor for calculating sizes of data fields for a displayed target data file on a frame basis, totaling the calculated sizes, code-converting a data file having the totaled size, and encoding the code-converted data file, wherein the encoding comprises parsing information about data fields in each frame of the target data file, and converting binary hex code data into code data being different from the hex code data.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a screen diagram illustrating an example of an operation of capturing target data displayed on a first terminal using a camera of a second terminal according to an embodiment of the present invention;

FIG. 2 is a flowchart illustrating a data transmission method according to an embodiment of the present invention; and

FIGS. 3A, 3B, and 4 are diagrams illustrating processes of encoding and decoding data according to an embodiment of the present invention.

Throughout the drawings, the same drawing reference numerals will be understood to refer to the same elements, features and structures.

### DETAILED DESCRIPTION OF THE INVENTION

Exemplary embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention relates generally to a data exchange between terminals capable of transmitting and receiving data, and more particularly, to a technology in which if target data displayed on a first terminal is converted into code data associated with data fields on a frame basis, and the code data is encoded after being divided in units of a predetermined number of bits, then a second terminal having captured the target data de-converts the target data into bits, decodes the bits into an image data file, and displays the image data file, thereby enabling a rapid data exchange between the terminals without separate connections (through wire/wireless networks, cables, etc.) and settings.

It will be apparent to those skilled in the art that the terminals to which an embodiment of the present invention is applicable, may include portable mobile communication terminals, including all information & communication devices and multimedia devices such as digital broadcasting terminals, Personal Digital Assistants (PDAs), smart phones, 3^{rd} Generation (3G) terminals (e.g., an International Mobile Telecommunication 2000 (IMT-2000) terminal, a Wideband Code Division Multiple Access (WCDMA) terminal, a Global System for Mobile communication/General Packet Radio Service (GSM/GPRS) terminal, and a Universal Mobile Telecommunication Service (UMTS) terminal.

Prior to a detailed description of the present invention, it is to be noted that a ‘first terminal’ refers to a transmitting terminal providing data, while a ‘second terminal’ refers to a receiving terminal that receives (or captures) data displayed on a screen of the first terminal using its camera, converts the received data into screen output image data, and displaying the screen output image data on its screen.

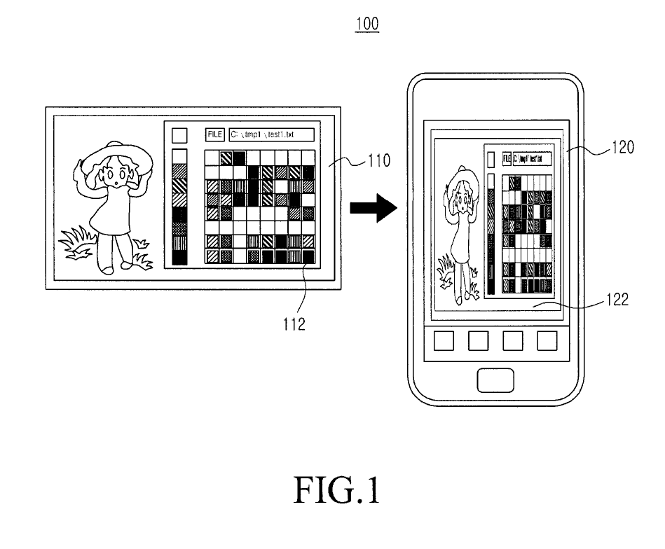

Hereinafter, an operation of a data file transmission system according to an embodiment of the present invention will be described in brief with reference to FIG. 1.

FIG. 1 illustrates an example of an operation of capturing target data displayed on a first terminal 110 using a camera (not shown) of a second terminal 120 according to an embodiment of the present invention.

Referring to FIG. 1, target data displayed on the first terminal 110, which may include a monitor, an electric signboard, and a portable terminal, is captured using a camera mounted in the second terminal 120. According to the teachings of the present invention, differences between the actual pixel data encoded by a first terminal 110 and the actual pixel data of frames output in the screen by the first terminal and received via a camera of a second terminal 120 are calibrated using a pixel chart used for calibration of pixel data during an exchange between the terminals, thus enabling data exchange between the terminals without separate connection (through wire/wireless networks, cables, etc.) and settings.

In operation, the first terminal 110 calculates sizes of data fields for a target data file displayed thereon on a frame basis, totals the calculated sizes of data fields, and performs a code conversion and encoding thereon. The encoding includes adding a pixel chart having a plurality of pixel data used for calibration of pixel data of a target data file during the code conversion on data fields of each frame of the target data file, and dividing it in units of a predetermined number of bits using the pixel data.

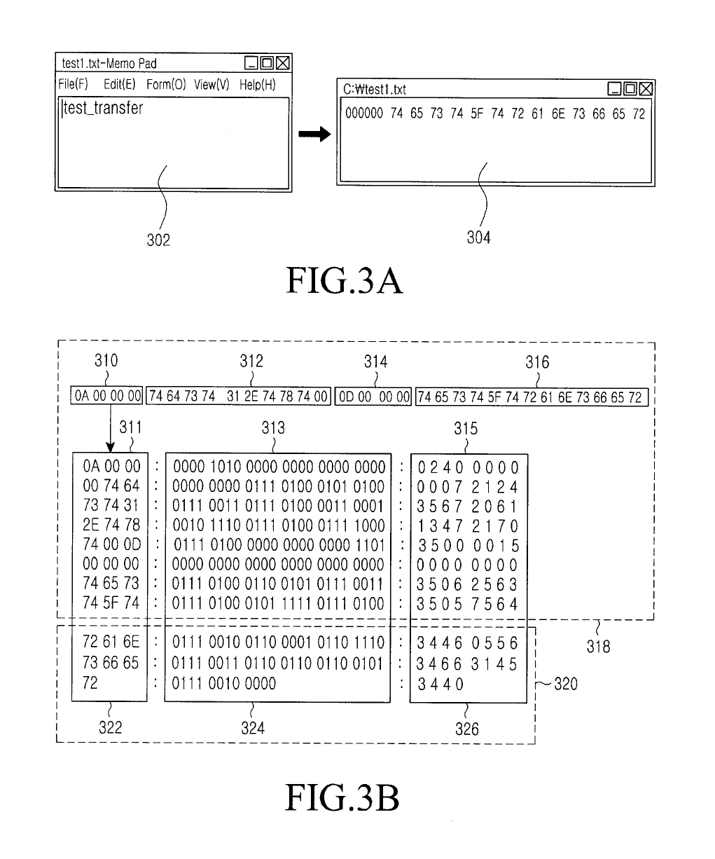

Referring to FIGS. 3A and 3B, binary hex values (e.g., 0000 74 65 73 74 5F 74 72 61 6E 73 66 65 72) of a text (e.g., ‘test_transfer’) of a target data file 302 displayed on the first terminal 110 are shown in FIG. 3A as represented by reference numeral 304. The first terminal 110 parses information about, for example, a header, a file name, a file length, and file data of each field of the target data file 302, divides binary hex values in units of a predetermined number of, for example, 3 bits using pixel values, and encodes the bits. The results are as shown in FIG. 3B.

For example, as to the calculated sizes of fields of the target data file 302 displayed on the first terminal 110, a header 310 (with a fixed length) has a 4-byte size ‘0x0000000A’, a file name 312 (with a variable length) has a 10-byte size ‘0x74 0x64 0x73 0x74 0x31 0x2E 0x74 0x78 0x74 0x11’, a file length 314 (with a fixed length) has a 4-byte size ‘0x0000000D’, and a file data 316 (with a variable length) has a 13-byte size ‘74 65 71 74 5F 74 72 61 6E 73 66 65 72’.

By totaling the calculated sizes of fields, a data file having a size of, for example, 4 bytes (file_name_len)+10 bytes (file_name)+4 bytes (file_len)+13 bytes (file_data)=31 bytes, is generated. Thereafter, by converting the hex code data into binary data and dividing it in units of 3 bits, the code data of fields are as shown by reference numerals 311, 313, and 315, respectively.

Thereafter, the second terminal 120 captures a target data file displayed on the first terminal 110 using its camera at N frames-per-second (fps) (where N is an integer), and decodes the captured data file. More specifically, the second terminal 120 de-converts the target data captured from the first terminal 110 into an image data file in units of a predetermined number of bits, and decodes the image data file. To be specific, the second terminal 120 parses a frame index of each frame for the target data file captured from the first terminal 110, searches for pixel data in the frame, calibrates each pixel using a pixel chart 112 included in the target data file, and decodes the calibrated pixel data in units of a predetermined number of bits. Note that pixel chart 112 is included in an encoding process of a first terminal 110 to transmit the target data to a second terminal 120. Thus, the pixel chart is added on the target data file during the encoding process of the first terminal.

Referring to FIG. 3B, a target data file 320 decoded by the second terminal 120 includes fields 322, 324 and 326 obtained by de-converting a target data file 318 captured from the first terminal 110 and encoded by the first terminal 110 in units of a predetermined number of bits, i.e., in units of 8 bits, and the target data file 320 decoded by the second terminal 120 is stored in or displayed on a display unit of the second terminal 120.

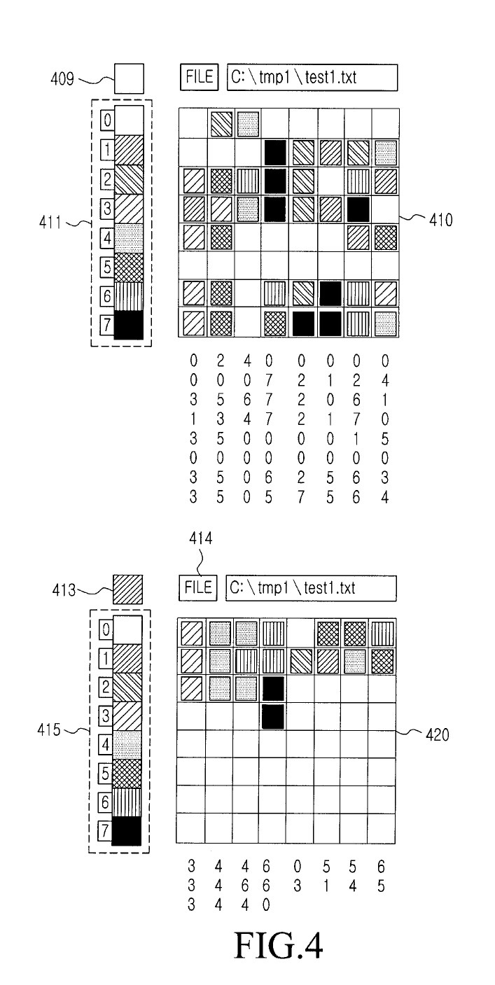

FIG. 4 illustrates an example in which a target data file encoded and transmitted by the first terminal 110 is decoded into an image data file by the second terminal 120.

Referring to FIG. 4, if pixel data 410 of a ‘file data’ field among the fields of the target data file is code-converted, encoded, and transmitted, then the encoded data is code-converted back, decoded, and displayed. The second terminal 120 searches for pixel data 420 by parsing a frame index of pixel data 420, sequentially compares the pixel data 420 in the frame using a pixel chart 415 added by the first terminal 110, calibrates a resolution of the pixel data 420, and converts the calibrated pixel data 420 into its screen output image data.

Accordingly, by merely capturing the data displayed on a screen of the external device, the same image data as the screen output image data 112 displayed on the first terminal 110 providing actual data may be displayed on the second terminal 120 without separate connections (through wire/wireless networks, cables, etc.) and settings, thus facilitating a data exchange between the first and second terminals 110 and 120.

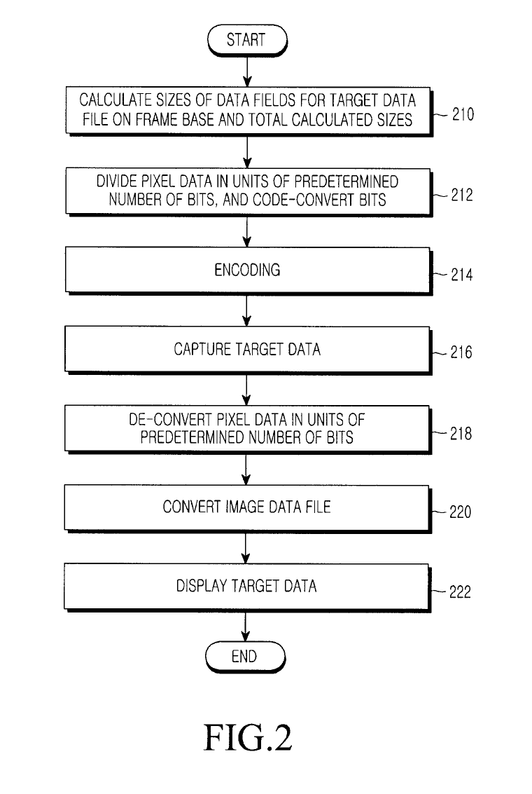

A data file transmission method according to an embodiment of the present invention will be described in detail herein below with reference to FIG. 2.

FIG. 2 illustrates a data transmission method according to an embodiment of the present invention.

Referring to FIG. 2, in step 210, sizes of data fields for a target data file displayed on a first terminal are calculated on a frame basis, and then totaled. For example, as for the calculated sizes of data fields of the target data file displayed on the first terminal 110, if a header (with a fixed length) has a 4-byte size, a file name (with a variable length) has a 10-byte size, a file length (with a fixed length) has a 4-byte size, and a file data (with a variable length) has a 13-byte size, then a data file having a size of 31 bytes, which is a total of the sizes, is generated.

In step 212, a pixel chart including a plurality of pixel data for calibration is added in pixel data of the target data file, and the pixel data are divided in units of a predetermined number of bits, and then code-converted. To be specific, hex code data is converted into binary data, and the binary data is divided in units of 3 bits, and code-converted. This operation is performed to improve a transfer speed, which is different according to the number of colors (4 bits for 16 colors, and 3 bits for 8 colors).

In step 214, the target data file code-converted in step 212 is encoded.

A second terminal captures the target data file encoded by the first terminal in step 216, and de-converts the captured target data file in units of a predetermined number of bits using pixel data in step 218. The second terminal parses a frame index of each frame for the de-converted target data file, calibrates the pixel data using a pixel chart included in each frame of the target data file, and converts the calibrated pixel data into an image data file in step 220.

As to the pixel chart, by sequentially comparing pixel data in a frame based on the pixel chart, a resolution, a speed, and horizontal and vertical ranges of the frame may be changed. In addition, the frame index means information generated by integrating information about a frame and location information about the frame. By parsing this frame index information, it is possible to determine the compression format of the frame and to access a plurality of pixel data included in the frame.

By sequentially comparing pixel data in a specific frame based on the pixel chart during conversion of the image data file, a representative brightness value or color value is determined for each pixel, improving a resolution of the image data. As a result, compared with the image data received through a camera, screen output image data converted from the image data may have a similar frame index to the screen output image data that was initially displayed.

In step 222, the decoded target data is displayed on or stored in a display unit of the second terminal.

As is apparent from the foregoing description, according to an exemplary embodiment of the present invention, a pixel chart is added during an encoding process by a first terminal and the captured output screen of the first terminal by a second terminal is decoded using the pixel chart. As such, differences between actual pixel data of frames of screen output image data received through a camera are calibrated using a pixel chart for calibration of pixel data during data exchange between terminals, thus enabling data exchange between terminals without separate connections (through wire/wireless networks, cables, etc) and settings.

In addition, binary hex code data of a target data file is encoded in units of a predetermined number of bits using pixel data, and then transmitted, and a receiving terminal having received the encoded target data file de-converts it in units of a predetermined number of bits and decodes the bits, thereby improving the data transfer speed and the time required for decoding.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for exchanging data, comprising:
a first terminal for calculating sizes of data fields for a displayed target data file on a frame basis, totaling the calculated sizes, code-converting a data file having the totaled size, and encoding the code-converted data file; and
a second terminal for capturing the target data file displayed on the first terminal using a camera at N frames-per-second (fps) (where N is an integer), and decoding the captured data file.

2. The system of claim 1, wherein the encoding by the first terminal comprises parsing information about data fields in each frame of the target data file, and converting binary hex code data into code data being different from the hex code data.

3. The system of claim 1, wherein the encoding by the first terminal comprises adding a pixel chart having a plurality of pixel data for calibration of pixel data of a data file during code conversion on data fields, and dividing the pixel data in units of a predetermined number of bits.

4. The system of claim 1, wherein the second terminal de-converts target data captured from the first terminal in units of a predetermined number of bits, converts the bits into an image data file, and decodes the image data file.

5. The system of claim 1, wherein the second terminal parses a frame index of each frame for the target data file captured from the first terminal, searches for pixel data in the frame, calibrates the pixel data using a pixel chart including a plurality of pixel data for calibration of the pixel data, and decodes the calibrated pixel data in units of a predetermined number of bits.

6. The system of claim 5, wherein the calibration comprises sequentially comparing pixel data in a frame based on the pixel chart to change a resolution of the frame.

7. A method for transmitting a data file, comprising:
calculating sizes of data fields for a displayed target data file on a frame basis, and totaling the calculated sizes;
parsing information about data fields in each frame of a data file generated to have the totaled size, converting binary hex code data into code data being different from the hex code data, and encoding the converted code data; and
capturing the target data at N frames-per-second (fps) (where N is an integer), de-converting the captured data in units of a predetermined number of bits, converting the bits into an image data file, and decoding the image data file.

8. The method of claim 7, wherein the encoding comprises dividing pixel data of a data file in units of a predetermined number of bits during code conversion on data fields.

9. The method of claim 7, wherein the decoding comprises parsing a frame index of each frame for the captured target data file, searching for pixel data in the frame, calibrating the pixel data using a pixel chart including a plurality of pixel data for calibration of the pixel data, and decoding the calibrated pixel data in units of a predetermined number of bits.

10. A display terminal for transmitting data, comprising:
a processor for calculating sizes of data fields for a displayed target data file on a frame basis, totaling the calculated sizes, code-converting a data file having the totaled size, and encoding the code-converted data file, wherein the encoding comprises parsing information about data fields in each frame of the target data file, and converting binary hex code data into code data being different from the hex code data.

11. The display terminal of claim 10, wherein the encoding further comprises adding a pixel chart having a plurality of pixel data for calibration of pixel data of a data file during the code conversion on data fields, and dividing the pixel data in units of a predetermined number of bits.

12. The display terminal of claim 11, wherein the encoded data file is captured by another terminal using a camera at N frames-per-second (fps) (where N is an integer), and decoding the captured data file.

13. The display terminal of claim 12, wherein the another terminal de-converts target data captured from the display terminal in units of a predetermined number of bits, converts the bits into an image data file, and decodes the image data file.

14. The display terminal of claim 13, wherein the another terminal parses a frame index of each frame for the target data file captured from the first terminal, searches for pixel data in the frame, calibrates the pixel data using a pixel chart including a plurality of pixel data for calibration of the pixel data, and decodes the calibrated pixel data in units of a predetermined number of bits.

15. The display terminal of claim 14, wherein the calibration comprises sequentially comparing pixel data in a frame based on the pixel chart to change a resolution of the frame.

16. A terminal for receiving a data file, comprising:
a camera for capturing a target data file displayed on another terminal N frames-per-second (fps) (where N is an integer) and decoding the captured data file,
wherein the captured data file is encoded by: calculating sizes of data fields for a displayed target data file on a frame basis, totaling the calculated sizes, code-converting a data file having the totaled size, and encoding the code-converted data file.

17. The terminal of claim 16, wherein the encoding further comprises parsing information about data fields in each frame of the target data file, and converting binary hex code data into code data being different from the hex code data.

18. The terminal of claim 17, wherein the encoding further comprises adding a pixel chart having a plurality of pixel data for calibration of pixel data of a data file during code conversion on data fields, and dividing the pixel data in units of a predetermined number of bits.

19. The terminal of claim 16, wherein the decoding comprises parsing a frame index of each frame for the target data file captured from the first terminal, searching for pixel data in the frame, calibrating the pixel data using a pixel chart including a plurality of pixel data for calibration of the pixel data, and decoding the calibrated pixel data in units of a predetermined number of bits.

20. The terminal of claim 19, wherein the calibration comprises sequentially comparing pixel data in a frame based on the pixel chart to change a resolution of the frame.
